(19) United States
(12) Patent Application Publication
(10) Pub. No.: US 2014/0337167 A1
(43) Pub. Date: Nov. 13, 2014

(54) METHOD FOR PERFORMING SOCIAL E-COMMERCE

(71) Applicants: Ze'ev ROZOV, London (GB); Ehud ZAGURI, Skanderborg (DK)

(72) Inventors: Ze'ev ROZOV, London (GB); Ehud ZAGURI, Skanderborg (DK)

(21) Appl. No.: 13/889,366

(22) Filed: May 8, 2013

(51) Int. Cl. G06Q 30/06

(52) U.S. Cl. CPC G06Q 30/0633
USPC 705/26.8

(57) ABSTRACT

The subject matter discloses a method comprising receiving data of a purchase transaction of a buyer purchasing a buyer's product, said purchase transaction is performed on a buyer's computerized device; sending a buyer's purchase information to members of at least one buyer's contact group; generating a buyer's list comprising the buyer; receiving data of buyers purchasing products; inserting buyers to the buyer's list; and, randomly selecting a selected buyer from the buyer's list.

### FIELD OF THE INVENTION

The subject matter relates generally to a method of performing social e-commerce in which a selected buyer receives a refund for a product purchased.

### BACKGROUND OF THE INVENTION

In commerce a party selling a particular good is regularly trying to create incentives to increase customer interest in purchasing particular products. These incentives may include sale discounts, wholesale discounts, selling the same item in a large quantity for a reduced price, and the like. Online providers try to create similar incentives for customers. For example, Amazon.com may offers discount prices for downloading certain artists' music depending on the popularity of the artist, or may offer a sale where the customer buys three books and receives the fourth hook for free. Service providers may look to give similar incentives. During tax season many online tax accountants may provide discounts on various additional services if the customer chooses to file taxes with the particular online tax accountant, for example help in preparing a long term investment plan.

### SUMMARY

It is an object of the subject matter to disclose a method comprising receiving data of a purchase transaction of a buyer purchasing a buyer's product, said purchase transaction is performed on a buyer's computerized device; sending a buyer's purchase information to members of at least one buyer's contact group; generating a buyer's list comprising the buyer; receiving data of buyers purchasing products; inserting buyers to the buyer's list; and, randomly selecting a selected buyer from the buyer's list.

In some cases, the method further comprises rewarding the selected buyer. In some cases, a reward to the selected buyer comprises refunding a product purchase price. In some cases, a reward to the selected buyer comprises an average reward value of a product purchase price of products purchased by buyers of the buyer's list.

In some cases, buyers are from the members of at least one buyer's contact group.

In some cases, products purchased by buyers are the buyer's product.

In some cases, products purchased by buyers are an equivalent product to the buyer's product.

In some cases, the method further comprises requesting from the buyer to send the buyer's purchase information to the members of at least one buyer's contact group.

In some cases the method further comprises removing the selected buyer from other lists for a product.

In some cases, the members of at least one buyer's contact group are contacts on a buyer's e-mail contact list.

In some cases, the buyer's purchase information is displayed on a buyer's social network webpage.

In some cases, a list is generated by a listing unit on a server. In some cases, the listing unit generates a profile of the buyer.

In some cases, the method is performed on a server. In some cases, selecting the selected buyer is performed by a selection unit. In some cases, refunding a product price is performed by a refund unit.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system for performing a purchaser refund, according to some exemplary embodiments of the subject matter;

FIG. 2 shows a method for performing social e-commerce, according to some exemplary embodiments of the subject matter;

FIG. 3 shows a form for submitting names of members of at least one buyer's social network, according to some exemplary embodiments of the subject matter; and,

FIG. 4 shows a buyer's list of buyers, according to some exemplary embodiments of the subject matter.

### DETAILED DESCRIPTION

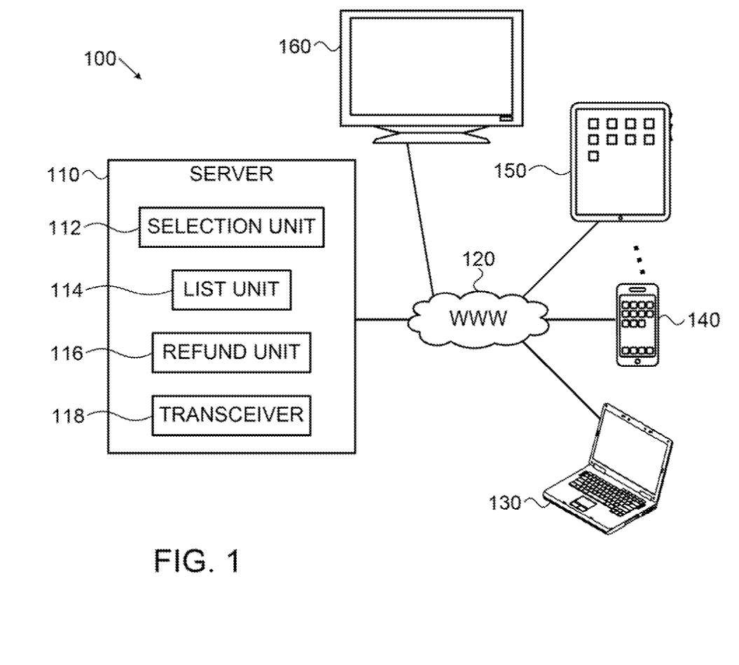

The subject matter discloses a method for refunding a purchase to a purchaser selected from a plurality of buyers, according to some exemplary embodiments of the subject matter. FIG. 1 shows a computerized network for performing social e-commerce, according to some exemplary embodiments of the subject matter. The computerized network 100 comprises of a server 110, which receives data related to a purchase transaction of a buyer's product by a buyer on a buyer's computerized device. The server 110 is connected to a world wide web (WWW) 120 through which the server may communicate with a buyer's computerized device, which is also connected to the WWW 120. The buyer's computerized device may be a buyer's desktop 130, a buyer's tablet 140, a buyer's mobile device 150, a television 160, or the like. The server 110, through a transceiver 118, receives data regarding the buyer's purchase transaction, for example, the server 110 receives data that the buyer purchased an online video game through the buyer's desktop 130 from Amazon.com. The server 110 receives data such as the name of the buyer, a buyer's product price, a date of purchase, a method of payment, and the like.

The server 110 transmits a message to the buyer's computerized device requesting permission send a buyer's purchase information to members of at least one buyer's contact group. The at least one buyer's contact group may be a buyer's e-mail contact list, a mobile phone contact list, a social network website, such as Facebook.com. Twitter.com, or the like. When the buyer permits the server 110 to send the buyer's purchase information to members of at least one buyer's contact group, the transceiver 118 transmits the buyer's purchase information. The transceiver 118 transmits the buyer's purchase information by sending an e-mail to the buyer's e-mail contact list, by sending a message to connections of the buyer on a buyer's social network webpage, attach the buyer's purchase information to the buyer's social network webpage, or the like. In some cases the server 110 sends the buyer's purchase information to the buyer's computerized device and the buyer sends the buyer's purchase information to the members of at least one buyer's contact group. For example, the buyer chooses the e-mail contacts and e-mails buyer's purchase information to the buyer's e-mail contacts.

The server 110 comprises a listing unit 114, which generates buyer's lists comprising buyers of a product. After the buyer agrees to send the buyer's purchase information, the listing unit 114 generates a buyer's list comprising the buyer of the product. When members of at least one buyer's contact group purchase the product through the buyer's purchase information transmitted by the server 110, the members of at least one buyer's contact group are added to the buyer's list as buyers. When each buyer of the buyers purchases the buyer's product, each buyer is requested to send a purchase information to at least one each buyer's contact group. After the buyers agree to send purchase information, the listing unit 114 generates a new buyer's list for each buyer. In some cases, the buyer's list may comprise additional information, such as a date of purchase of the buyer's product, a location in which the buyer's product was purchased by each buyer, and the like. The listing unit 114 updates the buyer's list when buyers that are members of at least one buyer's contact group purchase the buyer's product because of the buyer's purchase information sent by the server or the buyer. The listing unit 114 may have a predetermined quota for the size of the buyer's list generated. For example, the buyer's list may comprise a quota of up to eight buyers of the buyer's product before being closed off, the buyer's list may comprise all buyers that purchased the buyer's product within a month of the buyer purchasing the buyer's product, or the buyer's list may comprise all buyers that purchased the buyer's product within a similar location, such as all buyers within the city of Boston. In some exemplary embodiments of the subject matter, the listing unit 114 generates open lists to which buyers may be added when a buyer's list is closed. The listing unit 114 may complete a list generated by a buyer with buyers that did not receive the buyer's purchase information. For example, the buyer's purchase information was broadcasted to eight connections of the buyer, but only three of the connections bought the product advertised by the buyer's purchase information. The listing unit 114 may insert five additional buyers that purchased the product, but did not receive the buyer's purchase information.

The server 110 comprises of a selection unit 112. Once the buyer's list is closed, the selection unit randomly selects a selected buyer from the buyer's list. The selection unit 112 transfers the data of the selected buyer to a refund unit 116. The refund unit 116 provides a reward of a predetermined amount to the selected buyer. In some cases the rewards is a full refund of the buyer's product purchase price. The refund unit 116 may perform the reward by returning an amount paid by the selected by buyer a credit card company the selected buyer used to pay for the buyer's product, or the like. For example, in cases where the selected buyer purchased the product with a credit card, the refund unit 116 returns the credit to the credit card. The listing unit 114 stores the buyer's lists until the selected buyer is selected to receive the refund for the purchase of the buyer's product. In some exemplary embodiment of the subject matter, the listing unit 114 may generate a buyer profile for each buyer on the buyer's list. The buyer profile may comprise a name of the buyer, products the buyer purchased, which lists the buyer is on, payment information, address, date of birth, and the like. The buyer profile may be used by the server 100 to monitor the purchasing of each buyer and to monitor in which lists each buyer is inserted.

In some exemplary embodiments of the subject matter, the reward provided by the refund unit 116 may be an average reward value of purchase transactions by the buyers. For example, the buyer's product is $10 worth of credit of an online telephone service. The server 100 sends the buyer's purchase information to members of at least one buyer's contact group. The members of the at least one buyer's contact group purchase different amounts of credit of the online telephone service, for example a first member purchases $5 worth and a second member purchases $20 worth of credit of the online telephone service. The refund unit 116 may provide an average purchase value to the selected buyer. Where the second member is the selected buyer, the second member receives less than the purchase price paid for. However, where the first member is the selected buyer, the first member receives the average reward value with a higher amount than the purchase price of a first member's purchase transaction. Where the second member is the selected buyer, the second member receives the average reward value with a lower amount than the purchase price of a second member's purchase transaction.

In some exemplary embodiments of the subject matter, the products available for purchase by buyers are equivalent products sold by a seller, for example various types of LCD Televisions, e.g. from Samsung, Phillips, LG, and the like. The buyers elect the product to be purchased from a list of equivalent products, for which the full refund is available. The seller may require a minimum value for a product price, for example, the product is eligible for a complete refund when the product price is over 100 dollars.

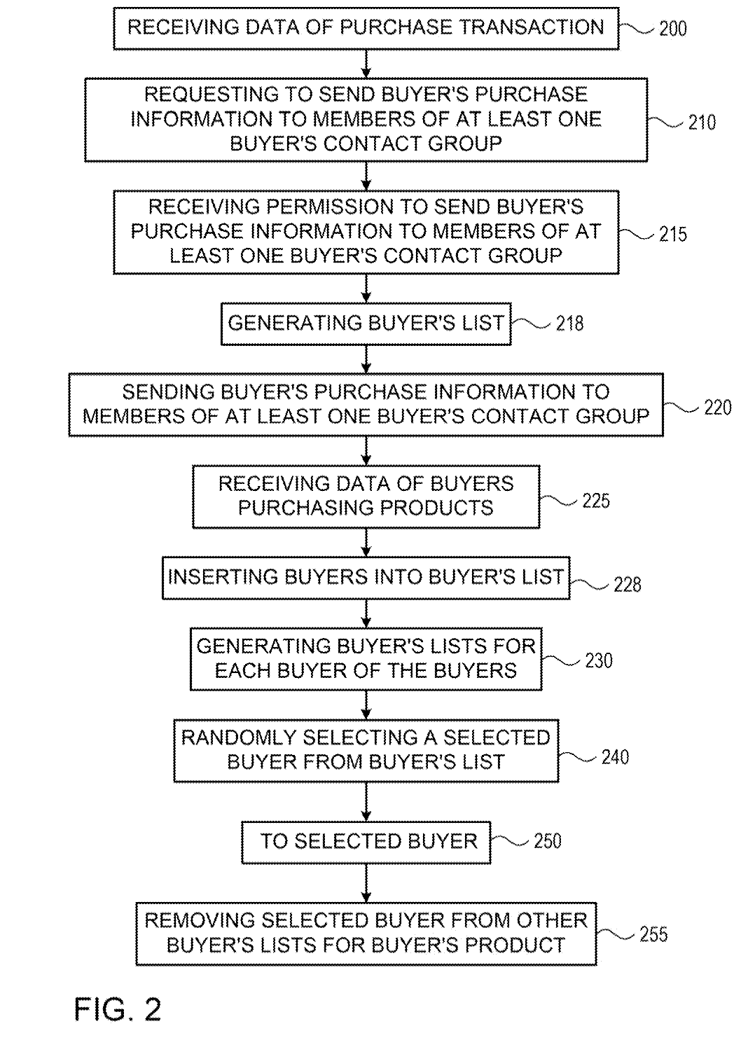

FIG. 2 shows a method for performing social e-commerce, according to some exemplary embodiments of the subject matter. Step 200 discloses receiving data of a purchase transaction of a buyer purchasing a buyer's product. The purchase transaction is performed by the buyer on a buyer's computer. The buyer computer may be the buyer's desktop 130 of FIG. 1 the buyer's tablet 140 of FIG. 1, the buyer's mobile device 150 of FIG. 1, or the like. The server 110 of FIG. 1 receives data that a buyer purchased the buyer's product, for example a new game to be played on a computer or tutoring lessons to learn Cantonese online. The server 110 receives the data of the purchase transaction, such as what the buyer purchased, the price of the purchase, the name of the buyer, contact information of the buyer, a time and date of the purchase, and the like.

Step 210 discloses the server 110 requesting to send a buyer's purchase information to members of at least one buyer's contact group. The buyer's purchase information may comprise the buyer's product, the price of the purchase, the name of the buyer, the time of the purchase, where the buyer's product was purchased. The server 110 sends to the buyer's computer a message requesting permission to share the buyer's purchase information with members of at least one buyer's contact group, for example, e-mail contacts on a buyer's e-contact list or a buyers connections on a social website, such as Facebook.com or Twitter.com. Step 215 discloses receiving permission to send the buyer's purchase information to the members of at least one buyer's contact group. The server 110 receives from the buyer's computerized device a message permitting the server 100 to send the buyer's purchase information to the members of the buyer's contact group. Step 218 discloses generating a buyer's list. The listing unit 114 of FIG. 1 generates the buyer's list comprising the buyer that agreed to send the buyer's purchase information. The buyers list is stored in the listing unit 114. The buyer's list is identified by the listing unit 114 according to a product purchased by the buyer and the buyer. The buyer's list may be arranged to place all buyers in a chronological order, alphabetically by the name of the buyer, or the like. The buyer's list may be generated to have a predetermined number of placements for buyers, for example, eight buyers complete a single byer's list. In other cases, the buyer's list may be completed after a predetermined amount of time, such as the buyers who purchase the product within a month from the time the buyer purchased the product. Step 220 discloses sending the buyer's purchase information to the members of at least one buyer's contact group. The server 110 receives from the computerized device contact information of members of at least one buyer's contact group. For example, the buyer inputs into the buyer's computerized device transmits e-mail addresses of buyer's contacts to the server 110. The e-mail addresses are received by the transceiver 118 of FIG. 1, which then sends the buyer's purchase information to the e-mail addresses of the buyer's contacts. In some cases, the server 110 receives permission to place the buyer's purchase information on a buyer's social page on the social website, for example, the server 110 receives permission to place the buyer's purchase information on a buyer's Twitter.com page, and the server 110 sends the buyer's purchase information to Twitter.com attach the buyer's purchase information to the buyer's Twitter.com page.

Step 225 discloses receiving data of buyers purchasing products. The server 110 receives data that buyers, which are members of at least one buyer's contact group, purchased either the buyer's product for which the buyer's purchase information was sent in step 220 or an equivalent product. The data from the buyers' may comprise a date of the purchases, location of purchase, and the like. In some exemplary embodiments of the subject matter, the buyers purchase products that are similar to the buyer's product. For example, the buyer's purchase information that is sent to the members of at least one buyer's contact group may comprise suggestion of similar products for the members to purchase, e.g. the buyer's product is a smartphone of a particular model, the buyer's purchase information recommends similar models of smartphones to the members. The members may purchase the similar smartphone models to be inserted into the buyer's list.

Step 228 discloses inserting buyers into the buyer's list. The server 110 receives data that of buyers purchasing the buyer's product after receiving the buyer's purchase information, for example through a link attached to the buyer's purchase information that took the buyers to an online location where the buyers may purchase the buyer's product. Data of the buyers is transferred to the listing unit 114, which inputs the buyers into the buyer's list. Step 230 discloses generating a separate buyer's list for each buyer of the buyers. Each buyer of the buyers that purchased the product is requested to send a product purchase information to members of at least one of each buyer's contact group. A separate buyer's list is generated by the listing unit 114 for each buyer that agrees to transmit each buyer's purchase information to members of at least one of each buyers contact group.

In some exemplary embodiments of the subject matter, the buyers may be inserted to the buyer's list from where the buyers purchase similar products to the buyer's product without receiving the buyer's purchase information. In such cases the buyer's list may be produced when there is an open for others buyer's list. The open for others buyer's list may occur where the buyer does not permit the server 110 to send the buyer's purchase information, or where the buyers purchase information is sent to a small number of a people but there are still empty spaces in the list. The server 110 may enable buyers of the buyers product or similar products to be inserted into the buyer's list and benefit from rewards available by the server 110.

Step 240 discloses randomly selecting one buyer from the list. Once the listing unit 114 reaches a quota of the buyer's list or the buyers list is closed from inserting further buyers, the selection unit 112 of FIG. 1 performs a random selection of a selected buyer from all buyers in the buyer's list. Step 250 discloses rewarding the selected buyer. Once the selected buyer is selected by the selection unit 112, the selected buyer receives a reward. The reward is performed by the refund unit 116 of FIG. 1, which a predetermined reward value to the selected buyer. In some cases the predetermined reward value may be a full refunding of the product purchase price. For example, the selected buyer purchased the buyer's product using a credit card on a website, the refund unit 116 transfers refund data, to the transceiver 118, which transmits the refund data to the credit card company. The refund data includes the product purchase price that is being refunded, the name of the person, the credit card number, and the like.

Step 255 discloses removing the selected buyer from other buyers' lists for the buyer's product. It should be noted that step 255 is an optional step. In the cases where the selected buyer received the refund from being in the list, the listing unit 114 removes the selected buyer from other buyers' lists the selected buyer may be in for the buyer's product. For example, the selected buyer received the buyer's purchase information. The selected buyer purchased the buyer's product after receiving the buyer's purchase information and is inserted into the buyer's list. The selected buyer enables the server 110 to send a selected buyer's purchase information to members of at least one selected buyer's contact group. After the server 110 sends the selected buyer's purchase information, a selected buyer's list is generated where the selected buyer is inserted as a first buyer of the selected buyer's list. Where the selected buyer is selected, the selected buyer is removed by the listing unit 114 from other selected buyer's list.

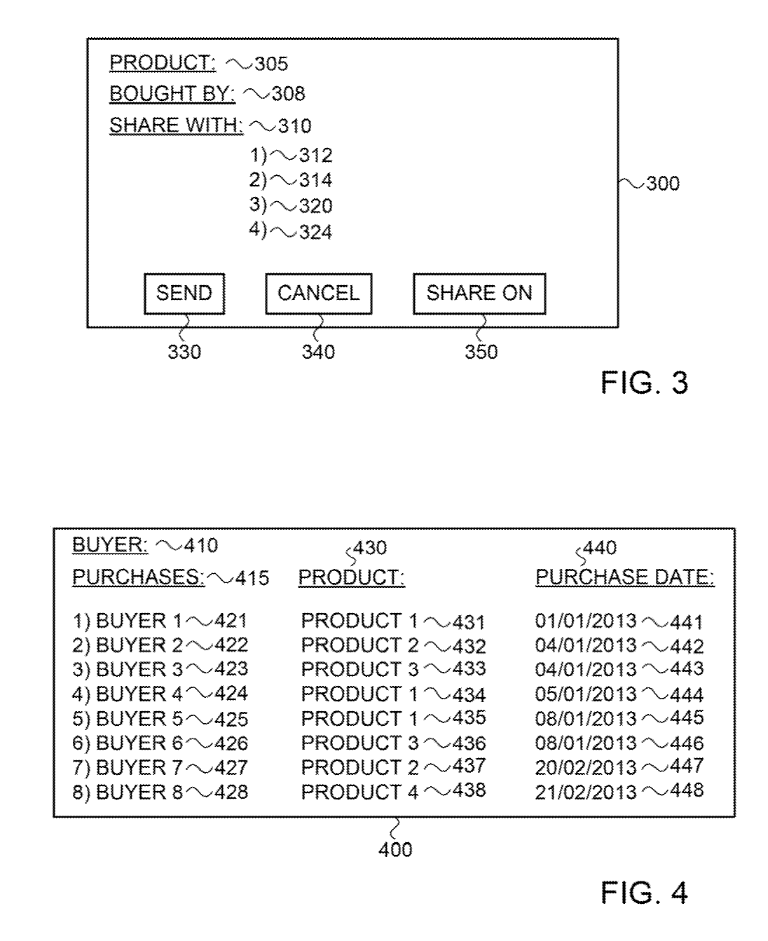

FIG. 3 shows a form for submitting names of members of at least one buyer's contact group, according to some exemplary embodiments of the subject matter. The form 300 is transmitted by the server 110 of FIG. 1 to a buyer's computerized device, such as the buyer's desktop 130 of FIG. 1, the buyer's tablet 140 of FIG. 1, the buyer's mobile device 150 of FIG. 1, or the like. The form is displayed on a display of the buyer's computerized device. The form 300 may appear after the buyer completes a purchasing transaction of a buyer's product through a website, for example, buying books on Amazon.com. The form 300 enables the buyer to send the server 110 contact information of members of at least one buyer's contact group to whom the buyer wants to send the buyer's purchase information. The form 300 may comprise a name of the buyer's product purchased 305 and a name of the buyer 308. The buyer may enter the names of the members of at least one buyer's contact group with whom the buyer wants to share the buyer's purchase information. The buyer inserts the contact information of the members of at least one buyer's contact group, for example, the buyer inserts e-mail addresses of contacts on a buyer's e-mail contact list into relevant locations 312, 314, 316, and 318 in the form 300. The form 300 may comprise a send button 330 to send the buyer's purchase information to the e-mail addresses that are inserted into the form 300. In some exemplary embodiments of the subject matter, a “share on” icon 350 may enable the buyer to share the buyer's purchase information on a buyer's contact group website page, for example, a buyer's Facebook.com webpage. The server 110 of FIG. 1 receives permission to post the buyer's purchase information on the buyer's social network page as a message on a buyer's Facebook.com wall. When buyer's friends on Facebook.com see the buyer's purchase information in the message, the friends may be able to follow a link in the message that transfers the buyer's friends to a website where the friends may purchase the buyer's product.

FIG. 4 shows a buyer's list of buyers, according to some exemplary embodiments of the subject matter. The buyer's list 400 may comprise of a name 410 of a buyer. The buyer's list 400 comprises of buyers 420, for example buyer's list 400 comprising of eight buyers: buyer 1 421, buyer 2 422, buyer 3 423, buyer 4 424, buyer 5 425, buyer 6 426, buyer 7 427 and buyer 8 428. Buyer 1 421 is a first buyer who purchased the buyer's product and from who a buyer's purchase information is sent to members of at least one buyer's contact group. All other buyers in the buyer's list 400 are inserted into the buyer's list 400 after purchasing the buyer's product. The buyer's list 400 may comprise the dates of purchases 440 made by the buyers, for example Jan. 1, 2013 440 is the date buyer 1 421 purchased the buyer's product, Apr. 1, 2013 442 and 443 is the date when buyer 2 422 and buyer 3 423 purchased the buyer's product, etc. The buyer's list 400 may comprise a description of the products purchased 430, for example, buyer 1 421 purchased product 1 431, buyer 2 422 purchased product 2 432, etc. After all spots on the buyer's list 400 are filled, the buyer's list 400 is used to randomly select a selected buyer.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method comprising:
receiving data of a purchase transaction of a buyer purchasing a buyer's product, said purchase transaction is performed on a buyer's computerized device;
sending a buyer's purchase information to members of at least one buyer's contact group;
generating a buyer's list comprising the buyer;
receiving data of buyers purchasing products;
inserting buyers to the buyer's list; and,
randomly selecting a selected buyer from the buyer's list.

2. The method of claim 1 further comprises, rewarding the selected buyer.

3. The method of claim 2, wherein a reward to the selected buyer comprises refunding a product purchase price.

4. The method of claim 2, wherein a reward to the selected buyer comprises an average reward value of a product purchase price of products purchased by buyers of the buyer's list.

5. The method of claim 1, wherein buyers are from the members of at least one buyer's contact group.

6. The method of claim 1, wherein products purchased by buyers are the buyer's product.

7. The method of claim 1, wherein products purchased by buyers are an equivalent product to the buyer's product.

8. The method of claim 1 further comprises, requesting from the buyer to send the buyer's purchase information to the members of at least one buyer's contact group.

9. The method of claim 1 further comprises, removing the selected buyer from other lists for a product.

10. The method of claim 1, wherein the members of at least one buyer's contact group are contacts on a buyer's e-mail contact list.

11. The method of claim 1, wherein the buyer's purchase information is displayed on a buyer's social network webpage.

12. The method of claim 1, where a list is generated by a listing unit on a server.

13. The method of claim 12, wherein the listing unit generates a profile of the buyer.

14. The method of claim 1, wherein the buyer's product is a service.

15. The method of claim 1, wherein the method is performed on a server.

16. The method of claim 15, wherein selecting the selected buyer is performed by a selection unit.

17. The method of claim 15, wherein refunding a product price is performed by a refund unit.
